(19) United States
(12) Patent Application Publication
(10) Pub. No.: US 2014/0320424 A1
(43) Pub. Date: Oct. 30, 2014

(54) DATA TRANSMISSION METHOD, TOUCH DATA PROCESSING METHOD AND ELECTRONIC DEVICE

(71) Applicant: Wistron Corporation, New Taipei City (TW)

(72) Inventors: Shi-Rui Lee, New Taipei City (TW); Chun-Tung Cheng, New Taipei City (TW)

(73) Assignee: Wistron Corporation, New Taipei City (TW)

(21) Appl. No.: 13/898,484

(22) Filed: May 21, 2013

(30) Foreign Application Priority Data
Apr. 26, 2013 (TW) 102115100

(51) Int. Cl. G06F 13/38; G06F 3/041

(52) U.S. Cl. CPC G06F 13/38; G06F 3/041
USPC 345/173

(57) ABSTRACT

A data transmission method is provided for an electronic device connecting with a multi-touch device through a plurality of low-speed serial buses. In the method, the multi-touch device senses a multi-touch action so as to generate an interrupt signal. The multi-touch device senses the multi-touch action through several touch points on the multi-touch device which the multi-touch action touches and generates a touch data respectively corresponding to each of the touch points. The interrupt signal from the multi-touch device is received. According to the interrupt signal, the touch data are respectively and sequentially received periodically through the low-speed serial buses.

### CROSS-REFERENCE TO RELATED APPLICATION

This application claims the priority benefit of Taiwan application serial no. 102115100, filed on Apr. 26, 2013. The entirety of the above-mentioned patent application is hereby incorporated by reference herein and made a part of this specification.

### BACKGROUND OF THE INVENTION

1. Field of Invention

The present invention relates to a data transmission method, a touch data processing method and an electronic device. More particularly, the present invention relates to a technology to a data transmission method, a touch data processing method and an electronic device using a plurality of low-speed serial buses to transmit data respectively.

2. Description of Related Art

Generally, the micro-controller utilizes the parallel buses. However, recently, new model micro-controller, except for the parallel buses, has the option of serial buses. The inter integrated circuit bus (I2C bus) is one of the serial buses can is widely used in the design of the micro-controller.

The inter integrated circuit bus, as implied by the name, is the communication buses between the integrated circuits. The traditional parallel buses adopts parallel structure (such 8 bit or 16 bit) so that the wirings between the integrated circuits is bulk and it needs decoding circuit which leads to complicated situation. The embedded element having the function of the inter integrated circuit bus can transmit data only through two lines but possesses much better reliability and security. Furthermore, the inter integrated circuit bus further accommodates several master integrated circuits thereon.

The inter integrated circuit bus is a kind of serial communication bus and is often used in the motherboard, the embedded system or mobile phone/tablet personal computer for connecting to the low-speed peripheral devices. Recently, the control of the mobile phone/tablet personal computer trends towards the multi-touch control. Even the control of the laptop and desktop trends towards to the multi-touch control. However, the low transmission speed of the inter integrated circuit bus leads to the implementation difficulty for applying the inter integrated circuit bus onto the multi-touch control.

### SUMMARY OF THE INVENTION

The present invention is to provide a data transmission method, a touch data processing method and an electronic device capable of transmitting a plurality of touch data sensed by the multi-touch device to the processor respectively through a plurality of low-speed serial buses so that different cores of the multi-core processor can process the input events respectively corresponding to the touch data at the same time to improve the performance for processing the events.

The invention provides a data transmission method for an electronic device, wherein the electronic device is connected to a multi-touch device through a plurality of low-speed serial buses. In the method, the multi-touch device senses a multi-touch action to generate an interrupt signal, wherein the multi-touch device senses the multi-touch action through a plurality of touch points on the multi-touch device and generates a touch data corresponding to each of the touch points. The interrupt signal from the multi-touch device is received. According to the interrupt signal, the touch data are received respectively and periodically through the low-speed serial buses.

According to one embodiment of the present invention, each of the low-speed serial buses includes an inter integrated circuit bus or a system management bus.

According to one embodiment of the present invention, the step of sequentially receiving the touch data respectively and periodically through the low-speed serial buses according to the interrupt signal comprises: transmitting the touch data respectively by the corresponding low-speed serial buses according to a signal control setting of the multi-touch device.

The invention also provides a touch data processing method for an electronic device, wherein the electronic device has a processor and the processor is connected to a multi-touch device through a plurality of low-speed serial buses. In the method, the processor receives an interrupt signal, wherein the interrupt signal is generated by the multi-touch device sensing a multi-touch action through a plurality of touch points on the multi-touch device and the multi-touch device generates a touch data respectively corresponding to each of the touch points. The processor receives the touch data from the multi-touch device respectively and periodically through the corresponding low-speed serial buses. The processor sequentially converts each of the touch data into an input event and processes each of the input event by the processor.

According to one embodiment of the present invention, each of the touch data includes a control code and a coordinate of the touch point corresponding to the touch data.

According to one embodiment of the present invention, the control code included in the touch data represents an identification code of the touch point corresponding to the touch data.

According to one embodiment of the present invention, each of the low-speed serial buses includes an inter integrated circuit bus or a system management bus.

According to one embodiment of the present invention, the processor sequentially receiving the touch data from the multi-touch device respectively and periodically through the corresponding low-speed serial buses comprises: the multi-touch device sequentially and respectively allocating the touch data to the low-speed serial buses to transmit to the electronic device according to a signal control setting.

The invention further provides an electronic device comprising a processor. The processor is connected to a multi-touch device through a plurality of low-speed serial buses. When the multi-touch device senses a multi-touch action through a plurality of touch points on the multi-touch device to generate an interrupt signal and generate a touch data corresponding to each of the touch points, the processor receives the interrupt signal, the processor sequentially receives the touch data from the multi-touch device respectively and periodically through the corresponding low-speed serial buses, the processor converts each of the touch data into an input event, and the processor processes each of the input event.

According to one embodiment of the present invention, each of the low-speed serial buses includes an inter integrated circuit bus or a system management bus.

According to one embodiment of the present invention, the processor sequentially receiving the touch data respectively and periodically through the corresponding low-speed serial buses comprises: the multi-touch device sequentially and respectively allocating the touch data to the low-speed serial buses to transmit to the electronic device according to a signal control setting.

According to one embodiment of the present invention, each of the touch data comprises a control code and a coordinate of the touch point corresponding to the touch data.

According to one embodiment of the present invention, the control code included in the touch data represents an identification code of the touch point corresponding to the touch data.

Accordingly, in the present invention, the multi-touch device is connected to the processor of the electronic device through a plurality of low-speed serial buses and the touch data of each of touch points on the multi-touch device touched by the multi-touch action are transmitted to the processor through the corresponding low-speed serial buses. Each of the touch data transmitted by different low-speed serial buses is converted into an input event and the multi-core processor treats the input events converted from the touch data transmitted by different low-speed serial buses and belonging to the same multi-touch action as different events to be processed. Therefore, the events can be respectively processed by different cores of the multi-core processor at the same time. Thus, the performance for processing the events is improved and the massive data and massive data transmission needed in the multi-touch technology can be handled in multi-tasking mode or discretely-tasking distribution mode.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an electronic device according to one embodiment of the present invention.

FIG. 2 is a flow chart illustrating a data transmission method for using low-speed serial buses to transmit touch data sensed by the multi-touch device according to one embodiment of the present invention.

FIG. 3 is a flow chart illustrating a touch data processing method according to one embodiment of the present invention.

### DESCRIPTION OF THE PREFERRED EMBODIMENTS

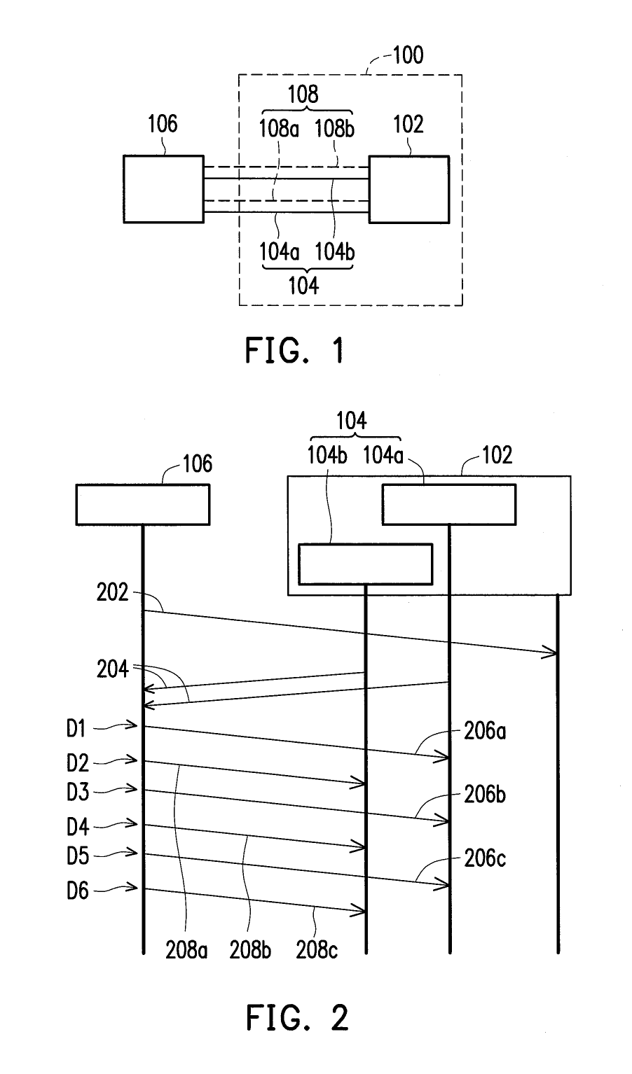

FIG. 1 is a schematic diagram showing an electronic device according to one embodiment of the present invention. As shown in FIG. 1, an electronic device 100 of the present embodiment comprises a processor 102. The processor 102 is connected to a multi-touch device 106 through a plurality of low-speed serial buses 104 (including the low-speed serial buses 104a and 104b). The aforementioned processor 102 can be, for example, the solo-core processor or the multi-core processor (including the dual-core processor, quad-core processor or hexa-core processor). Moreover, the aforementioned low-speed serial buses 104 can be, for example, the serial buses with the data transmission rate of about 10K bit/sec, 100 K bit/sec or 400 K bit/sec. More specifically, the aforementioned low-speed serial bus 104 can be, for example the inter integrated circuit bus (I2C bus) or the system management bus (SMBUS).

Further, the multi-touch device 106 uses the low-speed serial buses 104 as the data transmission interface to transmit the touch data to the processor 102 of the electronic device 100 and each of the low-speed serial buses 104 is provided with an interrupt line 108 (including the interrupt lines 108a and 108b) respectively connected the multi-touch device 106 to the processor 102. Each of the interrupt line 108 is used to transmit the interrupt signal to the processor 102 from the multi-touch device 106. In the present embodiment, two the low-speed serial buses 104 are user to connect the multi-touch device 106 to the processor 102. However, the present invention is not limited to the number of the low-speed serial buses 104. More specifically, the number of the low-speed serial buses 104 connected between the multi-touch device 106 and the processor 102 and used as the data transmission interface can be adjusted according to the maximum data processing speed of the processor 102 and the transmission speed of the low-speed serial buses 104 in used.

FIG. 2 is a flow chart illustrating a data transmission method for using low-speed serial buses to transmit touch data sensed by the multi-touch device according to one embodiment of the present invention. As shown in FIG. 1 and FIG. 2, when the multi-touch device 106 senses a multi-touch action on the multi-touch device 106 so as to generate an interrupt signal, the interrupt signal is transmitted to the processor 102 through the interrupt lines 108 (such as the interrupt signal transmission route 202) to notify the processor 102 that there are touch data waiting to be transmitted. The multi-touch action touches the multi-touch device 106 and the multi-touch device 106 senses the multi-touch action through a plurality of touch points on the multi-touch device 106 touched by the multi-touch action. The multi-touch device 106 generates a touch data corresponding to each of the touch points touched by the multi-touch action. The touch data comprises a control code and a coordinate of the touch point corresponding to the touch data. Moreover, the control code included in the touch data represents an identification code of the touch point corresponding to the touch data. Thus, the touch data can be matched to a touch point by referring to the control code.

Then, the processor 102 transmits a confirmation signal to the multi-touch device 106 respectively through the low-speed serial buses 104 (including 104a and 104b) to start to receive the touch data transmitted from the multi-touch device 106 (such as the confirmation signal route 204).

The processor 102 sequentially receives the touch data from the multi-touch device 106 respectively and periodically through the corresponding low-speed serial buses 104. For instance, the multi-touch device 106 sequentially and respectively allocates touch data to each of the low-speed serial buses according to a signal control setting so as to transmit the touch data to the electronic device 100. According to one embodiment, the signal control setting is that, according to a sequence of generating the touch data (i.e. the sequence of sensing the touch points on the multi-touch device touched by the multi-touch action), the touch data with the odd-number order in the sequence of generating the touch data (such as the touch data D1, D3 and D5) are sequentially transmitted to the processor 102 through the low-speed serial buses 104a (such as the transmission routes 206a, 206b and 206c) and the touch data with the even-number order in the sequence of generating the touch data (such as the touch data D2, D4 and D6) are sequentially transmitted to the processor 102 through the low-speed serial buses 104b (such as the transmission routes 208a, 208b and 208c).

More clearly, as for the touch data of the touch points on the multi-touch device 106 touched by the multi-touch action (including the touch data D1, D2, D3, D4, D5 and D6), the processor 102 receives the touch data D1 through the low-speed serial buses 104a first and then, in sequence, receives the touch data D2 through the low-speed serial buses 104b, the touch data D3 through the low-speed serial buses 104a, the touch data D4 through the low-speed serial buses 104b, the touch data D5 through the low-speed serial buses 104a and the touch data D6 through the low-speed serial buses 104b. That is, in the present embodiment, the multi-touch device 106 contiguously transmits the touch data to the processor 102 alternatively through the low-speed serial buses 104a and 104b. In the present embodiment, the multi-touch device 106, according to the signal control setting, transmits the touch data, in sequence of generating the touch data, to the processor 102 alternatively through the low-speed serial buses 104a and 104b. However, the present invention is not limited thereto. In other words, the multi-touch device 106 may sets the signal control setting according to other allocation principles to allocate the touch data to different low-speed serial buses 104 to be transmitted.

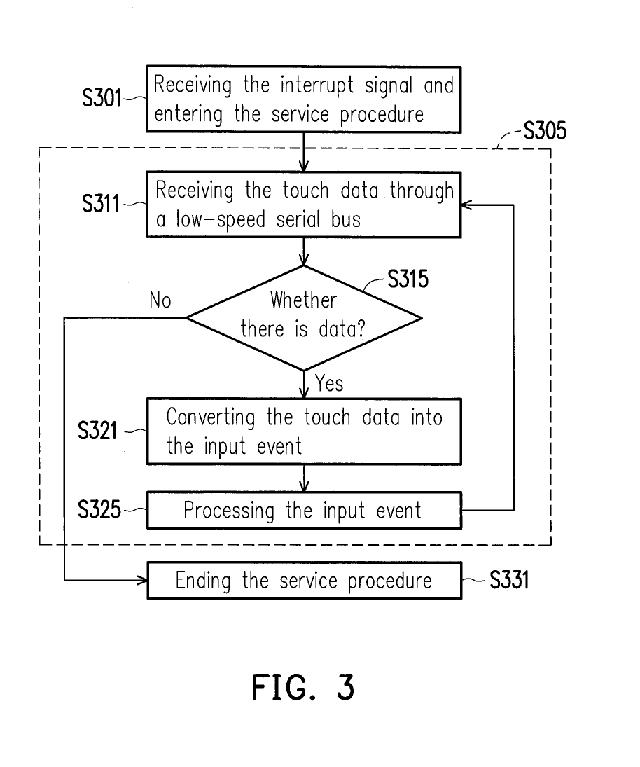

FIG. 3 is a flow chart illustrating a touch data processing method according to one embodiment of the present invention. As shown in FIG. 1, FIG. 2 and FIG. 3, after the processor 102 receives the interrupt signal from the multi-touch device 106 and enters a service procedure (i.e. a serial of processing procedure steps of receiving the touch data, converting the touch data into the input event and processing the input events) (step S301), the processor 102 sequentially receives the touch data respectively through each of the low-speed serial buses and performing the process procedure (step S305). In one embodiment, as for the touch data sequentially received from each of the low-speed serial buses 104 (step S311), the processor 102 determines whether there is data (step S315). When it is determined that there is no data, the service procedure is ended (step S331). When it is determined that the data actually exits, the processor 102 converts the touch data into an input event (step S321) and then continuously processes the input event (step S325). Again, in the step S311, when the processor 102 receives the touch data through another low-speed serial buses 104, repeatedly performs the serial steps S312 through S325 until it is determined that there is no data received in step S315, the service procedure is ended.

Altogether, in the present invention, the multi-touch device is connected to the processor of the electronic device through a plurality of low-speed serial buses and the touch data of each of touch points on the multi-touch device touched by the multi-touch action are transmitted to the processor through the corresponding low-speed serial buses. Each of the touch data transmitted by different low-speed serial buses is converted into an input event and the multi-core processor treats the input events converted from the touch data transmitted by different low-speed serial buses and belonging to the same multi-touch action as different events to be processed. Therefore, the events can be respectively processed by different cores of the multi-core processor at the same time. Thus, the performance for processing the events is improved and the massive data and massive data transmission needed in the multi-touch technology can be handled in multi-tasking mode or discretely-tasking distribution mode.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A data transmission method for an electronic device, wherein the electronic device is connected with a multi-touch device through a plurality of low-speed serial buses, the method comprising:
sensing a multi-touch action to generate an interrupt signal by the multi-touch device, wherein the multi-touch device senses the multi-touch action through a plurality of touch points on the multi-touch device and generates a touch data corresponding to each of the touch points;
receiving the interrupt signal from the multi-touch device; and
sequentially receiving the touch data respectively and periodically through the low-speed serial buses according to the interrupt signal.

2. The data transmission method of claim 1, wherein each of the low-speed serial buses includes an inter integrated circuit bus or a system management bus.

3. The data transmission method of claim 1, wherein the step of sequentially receiving the touch data respectively and periodically through the low-speed serial buses according to the interrupt signal comprises: transmitting the touch data respectively by the corresponding low-speed serial buses according to a signal control setting of the multi-touch device.

4. A touch data processing method for an electronic device, wherein the electronic device has a processor and the processor is connected to a multi-touch device through a plurality of low-speed serial buses, the method comprising:
receiving an interrupt signal by the processor, wherein the interrupt signal is generated by the multi-touch device sensing a multi-touch action through a plurality of touch points on the multi-touch device and the multi-touch device generates a touch data respectively corresponding to each of the touch points;
sequentially receiving the touch data from the multi-touch device respectively and periodically through the corresponding low-speed serial buses by the processor;
sequentially converting each of the touch data into an input event by the processor; and
processing each of the input event by the processor.

5. The touch data processing method of claim 4, wherein each of the touch data includes a control code and a coordinate of the touch point corresponding to the touch data.

6. The touch data processing method of claim 5, wherein the control code included in the touch data represents an identification code of the touch point corresponding to the touch data.

7. The touch data processing method of claim 4, wherein each of the low-speed serial buses includes an inter integrated circuit bus or a system management bus.

8. The touch data processing method of claim 4, wherein the processor sequentially receiving the touch data from the multi-touch device respectively and periodically through the corresponding low-speed serial buses comprises: the multi-touch device sequentially and respectively allocating the touch data to the low-speed serial buses to transmit to the electronic device according to a signal control setting.

9. An electronic device, comprising:
a processor, connected to a multi-touch device through a plurality of low-speed serial buses, wherein when the multi-touch device senses a multi-touch action through a plurality of touch points on the multi-touch device to generate an interrupt signal and generate a touch data corresponding to each of the touch points, the processor receives the interrupt signal, the processor sequentially receives the touch data from the multi-touch device respectively and periodically through the corresponding low-speed serial buses, the processor converts each of the touch data into an input event, and the processor processes each of the input event.

10. The electronic device of claim 9, wherein each of the low-speed serial buses includes an inter integrated circuit bus or a system management bus.

11. The electronic device of claim 9, wherein the processor sequentially receiving the touch data respectively and periodically through the corresponding low-speed serial buses comprises: the multi-touch device sequentially and respectively allocating the touch data to the low-speed serial buses to transmit to the electronic device according to a signal control setting.

12. The electronic device of claim 9, wherein each of the touch data comprises a control code and a coordinate of the touch point corresponding to the touch data.

13. The electronic device of claim 12, wherein the control code included in the touch data represents an identification code of the touch point corresponding to the touch data.
